(19) United States
(12) Patent Application Publication
(10) Pub. No.: US 2026/0046104 A1
(43) Pub. Date: Feb. 12, 2026

(54) SYSTEM AND METHOD FOR RATE MATCHING IN SUBBAND FULL DUPLEX OPERATION

(71) Applicant: Samsung Electronics Co., Ltd., Gyeonggi-do (KR)

(72) Inventors: Mohamed Mokhtar Gaber Moursi AWADIN, San Diego, CA (US); Jung Hyun BAE, San Diego, CA (US)

(21) Appl. No.: 19/294,948

(22) Filed: Aug. 8, 2025

Related U.S. Application Data
(60) Provisional application No. 63/681,118, filed on Aug. 8, 2024.
(60) Provisional application No. 63/750,273, filed on Jan. 27, 2025.

(51) Int. Cl. H04L 5/14; H04W 72/23

(52) U.S. Cl. CPC H04L 5/14; H04W 72/23

(57) ABSTRACT

A system and a method are disclosed for UE rate matching in SBFD operations. A method includes determining whether rate matching of a physical downlink (DL) shared channel (PDSCH) that crosses a boundary of a DL subband in a subband full duplex (SBFD) operation is to be counted towards a maximum limit on a number of rate matching patterns; and performing the rate matching of the PDSCH that crosses the boundary of the DL subband in the SBFD operation, based on the determination.

### CROSS-REFERENCE TO RELATED APPLICATION

This application claims the priority benefit under 35 U.S.C. § 119 (e) of U.S. Provisional Application Nos. 63/681,118 and 63/750,273, filed on Aug. 8, 2024, and Jan. 27, 2025, respectively, the disclosure of each of which is incorporated by reference in its entirety as if fully set forth herein.

### TECHNICAL FIELD

The disclosure generally relates to user equipment (UE) rate matching operations. More particularly, the subject matter disclosed herein relates to improvements to UE rate matching in subband full duplex (SBFD) operations.

### SUMMARY

In new radio (NR), a next generation Node B (gNB) can reserve time-frequency resources and label them as not being available for physical downlink (DL) shared channel (PDSCH) reception. Such reservation may be statically configured by higher layer signaling or dynamically indicated in DL control information (DCI), e.g., using a ‘Rate matching indicator’ field.

Static rate matching may be applied based on RateMatchPattern(s) configured in rateMatchPatternToAddModList in PDSCH-Config and may be referred to as a bandwidth part (BWP) list. Additionally, static rate matching can be applied based on RateMatchPattern(s) configured in rateMatchPatternToAddModList in ServingCellConfig or ServingCellConfigCommon and this list may be referred to as a serving-cell list.

For the dynamic indication, a gNB can configure a UE with two groups of rate matching patterns and select any of them using DCI. A “rate matching pattern” refers to a mechanism that allows 5G NR devices to intelligently avoid interfering with other radio signals, e.g., long term evolution (LTE) signals in a dynamic spectrum sharing (DSS) scenario. This may be achieved by configuring specific resource elements (REs) or resource blocks (RBs) as unavailable for PDSCH data allocation. Essentially, it is a way for 5G NR to coexist with existing infrastructure by rate matching around existing signals, ensuring efficient spectrum utilization. For example, radio resource control (RRC) parameters rateMatchPatternGroup1 and rateMatchPatternGroup1DCI-1-2 may be used to indicate identifiers (IDs) of RateMatchPatterns in the first group when using DCI 1_1 or DCI 1_2, respectively. Similarly, rateMatchPatternGroup2 and rateMatchPatternGroup2DCI-1-2 may be used to indicate IDs of RateMatchPatterns in the second group. When DCI activates group 1 or group 2, the UE applies rate matching around a union of the resources configured by RateMatchPattern(s) whose IDs are included in the activated group. Both groups can be activated simultaneously.

In each RateMatchPattern information element (IE), a gNB can provide a UE with reserved resources through the following information:
Bitmap (by RRC parameter resourceBlocks) may indicate reserved physical RBs (PRBs). Bitmap can be interpreted as per BWP or per serving-cell. If rateMatchPatternToAddModList is given by PDSCH-Config, then this bitmap may be interpreted as per BWP. On the other hand, rateMatchPatternToAddModList may be given by ServingCellConfig or by ServingCellConfigCommon, then this bitmap may be interpreted as per serving-cell.
PRBs may be spanned by a particular control resource set (CORESET) in all monitoring occasions configured by all search-space-sets associated with this CORESET.
Another two bitmaps may indicate the associated time domain positions of the reserved PRBs. One RRC parameter (symbolsInResourceBlock) may indicate which symbols within one or two slots have reserved PRBs, and another RRC parameter (periodicityAndPattern) may indicate the periodicity and pattern of the reserved PRBs.

When multicast and broadcast were specified in R17 NR, a similar framework as unicast was applied. Specifically, static rate matching may be applied based on RateMatchPattern(s) configured in rateMatchPatternToAddModList (excluding the ones used for dynamic rate matching) in pdsch-ConfigMulticast and this list may be considered as a BWP list.

Additionally, static rate matching can be applied based on RateMatchPattern(s) configured in rateMatchPatternToAddModList (excluding the ones used for dynamic rate matching) in pdsch-ConfigMCCH or pdsch-ConfigMTCH and this list may be considered as a serving-cell list.

Dynamic rate matching can be applied for multicast only. Specifically, rateMatchPatternGroupl and rateMatchPatternGroup2 in pdsch-ConfigMulticast may be used based on an indication in DCI format 4_1.

In NR, a UE may be configured with up to 4 RateMatchPattern(s) per BWP, i.e., in the BWP list, and up to 4 RateMatchPattern(s) per serving-cell, i.e., in the serving-cell list. That is, the UE has a BWP limit of 4 patterns and a serving-cell limit of 4 patterns.
If rateMatchPatternToAddModList is in PDSCH-Config, the indicated RateMatchPattern(s) in this BWP list may be counted towards a BWP limit.
If rate MatchPatternToAddModList is ir ServingCellConfig, or ServingCellConfigCommon, the indicated RateMatchPattern(s) in this serving-cell list may be counted towards a serving-cell limit.
If rateMatchPatternToAddModList is in pdsch-ConfigMulticast, the indicated RateMatchPattern(s) in this list may be counted towards the serving BWP limit.
If rateMatchPatternToAddModList is in pdsch-ConfigMCCH or pdsch-ConfigMTCH, the indicated RateMatchPattern(s) in this list may be counted towards the serving-cell limit.

An SBFD operation provides the ability to operate uplink (UL) and DL simultaneously within a same time division duplexing (TDD) carrier, using non-overlapping frequency subbands. In an SBFD operation, for a PDSCH crossing a DL subband boundary, i.e., for a PDSCH spanning a UL subband, a UE may rate match the PDSCH around RBs outside the DL subband. That is, all assigned PRBs that fall outside of DL usable PRBs may be considered to be invalid and should not be used for PDSCH resource mapping.

FIG. 1 illustrates an example in which a PDSCH crosses boundaries of DL subbands in an SBFD operation.

Referring to FIG. 1, a PDSCH 101, which is illustrated as black, a UL subband 102, which is illustrated as gray, and DL subbands 103a and 103b, which are illustrated as white, are provided over frequency and time resources in an SBFD operation. As illustrated in FIG. 1, a portion of a wide bandwidth carrier may be used for a different direction than that of the rest of the carrier. That is, unlike a TDD where the entire bandwidth on the left side is used for DL transmission, the center portion of an SBFD carrier is used for UL reception, i.e., the UL subband 102, while the rest of the carrier, i.e., DL subbands 103a and 103b, is used for DL transmission. A boundary 104a represents a lower frequency threshold of the DL subband 103a and a boundary 104b represents an upper frequency threshold of the DL subband 103b.

As illustrated in FIG. 1, the PDSCH 101 crosses the boundaries 104a and 104b by extending beyond the DL subband 103b into the DL subband 103b. That is, the PDSCH 101 extends beyond the lower frequency threshold of the DL subband 103a and the upper frequency threshold of the DL subband 103b. Since the PDSCH 101 crosses the boundaries 104a and 104b of the DL subbands 103a and 103b, i.e., the PDSCH 101 spans the UL subband 102 and overlaps the DL subbands 103a and 103b, in the SBFD operation, rate matching may be conducted around the UL subband 102. RBs and symbols occupied by the UL subband 102 may be considered unavailable for PDSCH allocation, similar to those configured by rate matching patterns.

In accordance with the foregoing, a need exists for how PDSCH rate matching for SBFD operations are to be counted towards a UE's general rate matching capabilities.

To address these issues, systems and methods are described herein for UE rate matching in SBFD operations. More specifically, methods are described herein in which UE rate matching for a PDSCH around a UL subband in an SBFD operation may be counted towards a UE's rate matching limit per serving-cell or BWP.

Methods are described herein in which unnecessary counting of rate matching may be avoided when rate matching of a PDSCH around a UL subband may not be required.

Methods are described herein for a UE when rate matching a PDSCH around a UL subband may be beyond the UE's capabilities.

Methods are described herein in which rate matching of a PDSCH around a UL subband may be counted separately from a UE's rate matching limit per serving-cell or BWP.

In accordance with embodiments of this disclosure, a UE can indicate, to a gNB, how rate matching for a PDSCH crossing a DL subband in an SBFD operation may be counted towards its rate matching capability limits, e.g., a number of possibly configured RateMatchPattern(s) per BWP or per serving-cell. For example, the UE can indicate, to the gNB, via capability signaling, how many times rate matching can be counted and/or whether the counting is toward the limit of rate matching capability per BWP, i.e., BWP limit, or per serving-cell, i.e., cell limit.

In accordance with embodiments of this disclosure, the counting of rate matching a PDSCH crossing a DL subband in an SBFD operation toward the limit of rate matching capability per BWP or per serving-cell may depend on a configuration of a UL/DL subband. For example, if a UL/DL subband may be cell-specific, the counting may be toward a cell limit, or if a UL/DL subband may be UE-specific, the counting may be toward a BWP limit.

In accordance with embodiments of this disclosure, if an active DL/UL BWP does not overlap with a cell-specific DL/UL subband, the limit of RateMatchPattern(s) for the active DL/UL BWP may not be affected as no rate matching for an SBFD operation will occur.

In accordance with embodiments of this disclosure, the counting rate matching for a PDSCH crossing a DL subband in an SBFD operation towards a limit of RateMatchPattern(s) per serving-cell may depend on whether an active DL/UL BWP overlaps with a cell specific DL/UL subband.

In accordance with embodiments of this disclosure, solutions are also provided for when a BWP or cell limit may be exceeded.

In accordance with embodiments of this disclosure, a gNB may indicate in which BWP or cell, rate matching for a PDSCH crossing a DL subband in an SBFD operation may be counted toward the UE's limit of RateMatchPattern(s). If no indication is provided, the gNB may ensure that the PDSCH may be fully confined within a DL subband.

In accordance with embodiments of this disclosure, a UE can separately indicate a number of BWPs, component carriers (CCs), i.e., individual carrier frequencies that may be aggregated with other carriers to form a larger bandwidth for increased data rates, and/or cells in which rate matching can be applied for a PDSCH crossing a DL subband.

In accordance with embodiments of this disclosure, for a dynamic SBFD operation, rate matching for a PDSCH crossing a DL subband can be counted toward a limit of a rate matching pattern group for dynamic rate matching. For example, rate matching for a PDSCH crossing a DL subband can be counted a multiple of times based on UE capability or predefined values, or can be counted toward a first group of dynamic rate matching patterns.

The above approaches improve on previous methods because they provide a clear frame to reflect the complexity of rate matching in an SBFD operation, provide criteria to determine how a rate matching pattern for rate matching a PDSCH around a UL subband is to be counted toward a serving-cell limit or a BWP limit, and allow a UE to indicate, to a gNB, a separate limit on rate matching patterns, which differs from a rate matching pattern limit per BWP and/or per serving-cell.

In an embodiment, a method performed by a UE comprises determining whether rate matching of a PDSCH that crosses a boundary of a DL subband in an SBFD operation is to be counted towards a maximum limit on a number of rate matching patterns; and performing the rate matching of the PDSCH that crosses the boundary of the DL subband in the SBFD operation, based on the determination.

In an embodiment, a user equipment (UE) comprises a transceiver; and a processor configured to determine whether rate matching of a PDSCH that crosses a boundary of a DL subband in an SBFD operation is to be counted towards a maximum limit on a number of rate matching patterns, and perform the rate matching of the PDSCH that crosses the boundary of the DL subband in the SBFD operation, based on the determination.

In an embodiment, a method performed by a base station comprises receiving, from a UE, a capability signal indicating whether rate matching of a PDSCH that crosses a boundary of a DL subband in an SBFD operation is to be counted towards a maximum limit on a number of rate matching patterns; and transmitting the PDSCH based on the indication.

### BRIEF DESCRIPTION OF THE DRAWING

In the following section, the aspects of the subject matter disclosed herein will be described with reference to exemplary embodiments illustrated in the figures, in which:

FIG. 1 illustrates an example in which a PDSCH crosses boundaries of DL subbands in an SBFD operation;

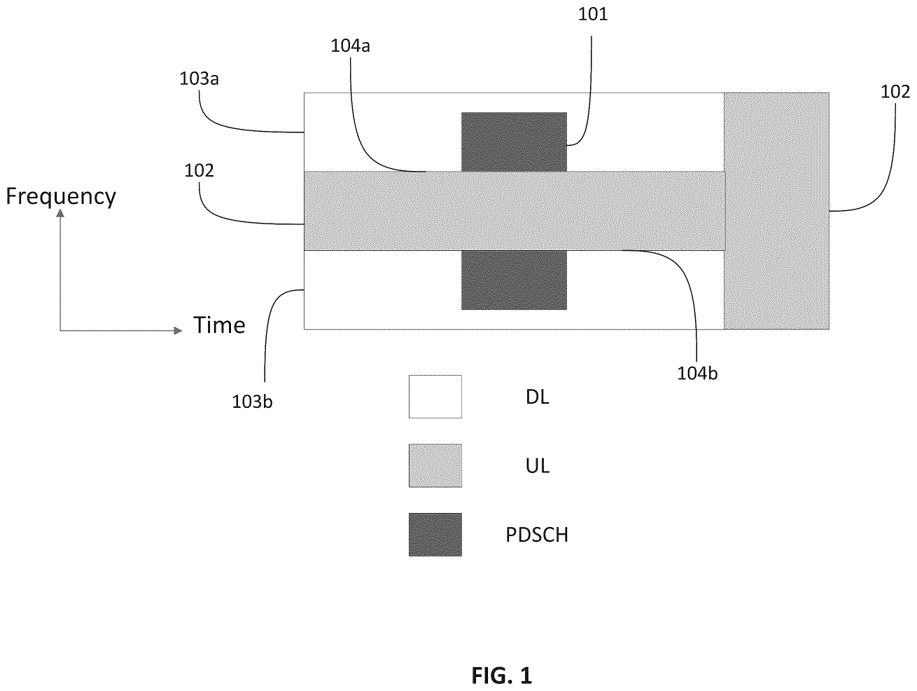

FIG. 2A illustrates an example of an active DL/UL BWP not overlapping with a cell-specific DL/UL subband, according to an embodiment;

FIG. 2B illustrates an example of an active DL/UL BWP overlapping with a cell-specific DL/UL subband, according to an embodiment;

FIG. 3 is a flow chart illustrating a method performed by a UE, according to an embodiment;

FIG. 4 is a flow chart illustrating a method performed by a gNB, according to an embodiment;

FIG. 5 is a block diagram of an electronic device in a network environment, according to an embodiment; and

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In 5G NR, frequency bands may be categorized into two main frequency ranges (FRs), i.e., FR1, which may include sub-7 GHz frequency bands, from 410 MHz to 7125 MHZ, and FR2, which may include frequency bands from 24.25 GHz to 71.0 GHz. Within these FRs, 5G may utilize the concept of subbands to manage and allocate resources within a broader channel bandwidth.

A BWP may be a mechanism to divide a channel band into multiple segments or subbands. The BWPs can be switched dynamically and may be a function of specific network conditions or UE requirements, which may result in resource allocation specific to a service and traffic configuration/type/etc. Utilizing BWPs with techniques like SBFD can significantly improve uplink throughput, especially in scenarios like dense urban environments.

Cell-specific subbands in 5G allow network operators to portion the available spectrum, dynamically allocate resources, and improve network efficiency and performance for specific cell conditions and traffic demands.

In NR, a frequency domain location of a DL/UL subband may be a cell-specific configuration where the subband location is common to all UEs. The start of a cell-specific subband may be defined relative to a PRB determined based on each subcarrier spacing (SCS) configured in SCS-SpecificCarrierList and offsetToCarrier to the SCS. In other words, a first RB of a subband is defined relative to a first RB in a carrier. In terms of signaling, either common signaling or UE dedicated signaling can be used to convey cell-specific configurations of the UL subband frequency location.

As yet another possibility, the frequency location of a DL/UL subband may be a UE-specific configuration that varies across different UEs. For example, this may be beneficial if a guardband between a DL subband and a UL subband varies among the UEs.

A UE performs rate matching for a PDSCH, when some of the assigned PRBs for the PDSCH are outside of the usable RBs in the DL subband.

Herein, reducing a number of possibly configured RateMatchPattern(s) per BWP or per serving-cell, i.e., a UE's rate matching capability limits, may be equivalent to counting rate matching of a PDSCH crossing a boundary of a DL subband towards the limits that are configured per BWP or per serving-cell, respectively. A serving-cell may be a cell that the UE is currently connected to and actively using for data and/or control communication. For example, a serving-cell can be a primary cell (PCell) or a special cell (SpCell), potentially with one or more secondary cells (SCells).

According to an embodiment, rate matching of a PDSCH crossing boundaries of a DL subband in an SBFD operation may be counted against a number of available RateMatchPattern(s) per BWP or per serving-cell.

More specifically, regardless of whether a DL/UL subband is cell-specific or UE specific, if a UE supports rate matching of a PDSCH crossing boundaries of a DL subband, the number of available RateMatchPattern(s) per BWP or per serving-cell may be reduced by factor β. For example, assuming a UE may be configured with up to 4 RateMatchPattern(s) per BWP, and up to 4 RateMatchPattern(s) per serving-cell, a remaining budget to configure RateMatchPattern(s) may become 4−β RateMatchPattern(s) per BWP or per serving-cell. That is, rate matching of a PDSCH crossing boundaries of DL subband in an SBFD operation may be counted β times, in addition to the RateMatchPattern(s) configured per BWP or per serving-cell, respectively.

The value of β may be predefined, e.g., provided in specifications, and it may be equal to one. Alternatively, a UE may indicate, to a gNB, a value of β via capability signaling. The value of β may be an integer value that is less than or equal to 4.

Additionally, a UE may indicate, to a gNB, via capability signaling, whether a reduction is applied to the number of possibly configured RateMatchPattern(s) per BWP or per serving-cell. That is, a UE may indicate, to a gNB, whether rate matching of a PDSCH crossing boundaries of a DL subband in an SBFD operation may be counted in the RateMatchPattern(s) configured per BWP or per serving-cell, respectively. For example, a UE may indicate a value of β to be applied to the limit of RateMatchPattern(s) per BWP. Another UE may indicate a different value of β to be applied to the limit of RateMatchPattern(s) per serving-cell. Yet another UE may indicate a different value of β to be applied to both limits of RateMatchPattern(s) per BWP and RateMatchPattern(s) per serving-cell.

Alternatively, a UE may indicate that rate matching of a PDSCH crossing boundaries of a DL subband in an SBFD operation may be counted β times, in addition to the RateMatchPattern(s) configured per BWP. Another UE may indicate that rate matching of a PDSCH crossing boundaries of DL subband in an SBFD operation may be counted as a different value of β times, in addition to the RateMatchPattern(s) configured per serving-cell. Yet another UE may indicate that rate matching of a PDSCH crossing boundaries of a DL subband in an SBFD operation may be counted as a different value of β times, in addition to both the RateMatchPattern(s) configured per BWP and the RateMatchPattern(s) configured per serving-cell.

According to an embodiment, applying a reduction to limit of the possibly configured RateMatchPattern(s) per BWP, per serving-cell, or both, may be predefined, i.e., provided in specifications. That is, whether to count rate matching of a PDSCH crossing boundaries of DL subbands in an SBFD operation as a RateMatchPattern per BWP, per serving-cell, or both, may be predefined, i.e., provided in specifications.

If performing rate matching for a PDSCH crossing a DL subband in an SBFD operation results in reduction of both limits of the possibly configured RateMatchPattern(s) per BWP and per serving-cell, separate reduction parameters may be applied. For example, a numerical limit β may be applied to the limit of possibly configured RateMatchPattern(s) per BWP and a numerical limit a may be applied to the limit of possibly configured RateMatchPattern(s) per serving-cell. In other words, rate matching of a PDSCH crossing boundaries of DL subbands in an SBFD operation may be counted as β RateMatchPattern(s) per BWP and a RateMatchPattern(s) per serving-cell.

The value of a may be determined using any of the aforementioned methods to determine β, e.g., indicated via UE capability or provided in specifications.

Alternatively, the value of α may be determined as a function of β, or other way around. For example, α=ϵ×β, where a numerical scaling factor e may be predefined, e.g., provided in specifications, ϵ=0.5, or may be indicated via UE capability signaling, e.g., RRC.

Determining whether a reduction may be applied to the limit of RateMatchPattern(s) per BWP or the limit of RateMatchPattern(s) per serving-cell, or whether to count rate matching of a PDSCH crossing boundaries of DL subbands in an SBFD operation towards RateMatchPattern(s) per BWP or per serving-cell may depend on whether the subband is cell-specific or UE-specific.

For example, if a frequency location of a subband is cell-specific, the limit of possibly configured RateMatchPattern(s) per serving-cell may be reduced by β. That is, rate matching of a PDSCH crossing boundaries of DL subbands in an SBFD operation may be counted β times, in addition to the configured RateMatchPattern(s) per serving-cell. The aforementioned approaches may be used to determine β, e.g., either predefined in specifications or signaled via UE capability signaling.

However, if a frequency location of a subband is UE-specific, the limit of possibly configured RateMatchPattern(s) per BWP may be reduced by α. That is, rate matching of a PDSCH crossing boundaries of DL subbands in an SBFD operation may be counted as a times, in addition to the configured RateMatchPattern(s) per BWP. The aforementioned approaches may be used to determine α, e.g., α may be predefined in specifications or signaled via UE capability signaling.

Additionally, even if a frequency domain location of a subband may be cell-specific, performing rate matching of a PDSCH outside of a DL subband can be counted towards the limit of the possibly configured RateMatchPattern(s) per BWP, in addition to the limit of the possibly configured RateMatchPattern(s) per serving-cell. Conversely, if a frequency domain location of a subband may be UE-specific, performing rate matching of a PDSCH outside of a DL subband can be counted towards the limit of the possibly configured RateMatchPattern(s) per serving-cell in addition to the limit of the possibly configured RateMatchPattern(s) per BWP. As described above, performing rate matching of a PDSCH outside of a DL subband can be counted differently by defining two parameters, α and β, whose values may be predefined in specifications or signaled via UE capability signaling.

When rate matching of a PDSCH crossing boundaries of DL subbands in an SBFD operation is counted towards the limit of RateMatchPattern(s) per BWP or/and per serving-cell, it may be beneficial to determine when such counting occurs. Specifically, this may avoid unnecessary reduction of the RateMatchPattern(s) per BWP or/and per serving-cell.

For example, UL usable PRBs within a UL subband may be determined as an intersection between a cell-specific UL subband and a UL BWP in SBFD symbols. Similarly, DL usable PRBs within a DL subband may be determined as an intersection between cell-specific DL subband(s) and a DL BWP in SBFD symbols. Therefore, when an active DL/UL BWP does not overlap with a cell-specific DL/UL subband, the PDSCH will not be rate matched around the UL subband. In this case, it may be beneficial that a limit of RateMatchPattern(s) for this active BWP is not affected.

Similarly, if rate matching of a PDSCH crossing boundaries of DL subbands may be counted towards the limit RateMatchPattern(s) per serving-cell, this counting may not be utilized when an active DL/UL BWP may not overlap with a cell-specific DL/UL subband. Accordingly to an embodiment, whether or not rate matching of a PDSCH crossing boundaries of DL subbands may be counted towards the limit RateMatchPattern(s) per serving-cell may depend on an active DL/UL BWP. An active DL/UL BWP for a UE determines a specific frequency range and numerology (e.g., SCS and cyclic prefix) the UE uses for DL and/or UL communication.

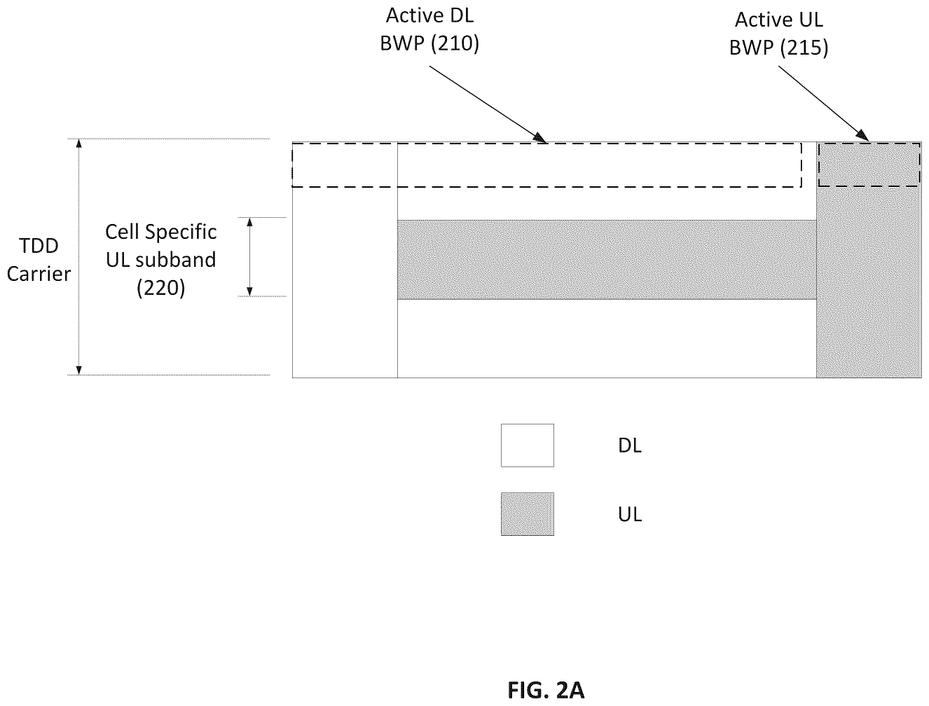

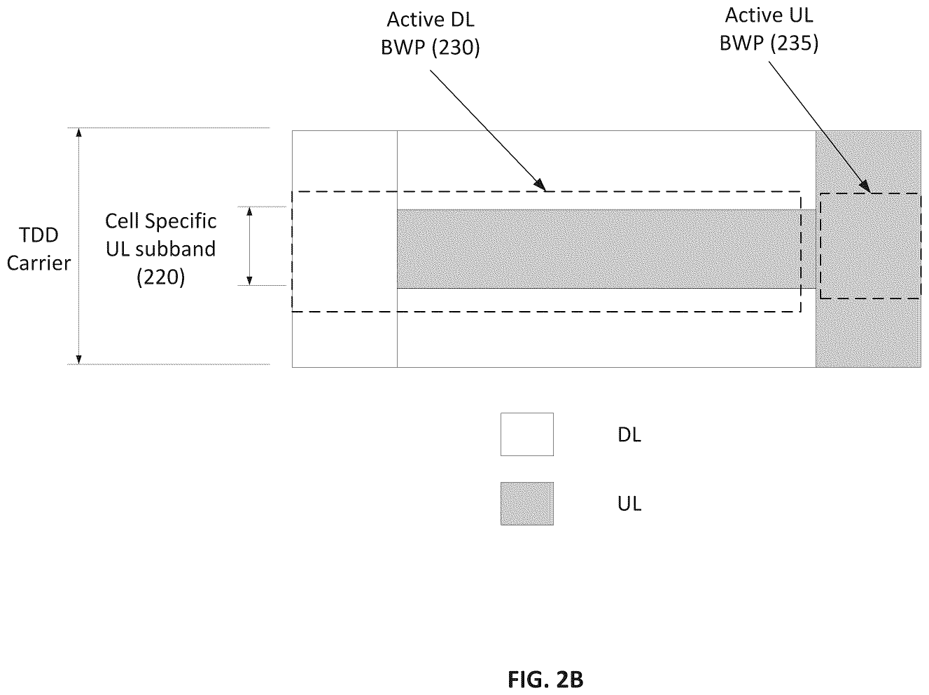

FIG. 2A illustrates an example of an active DL/UL BWP not overlapping with a cell-specific DL/UL subband, according to an embodiment, and FIG. 2B illustrates an example of an active DL/UL BWP overlapping with a cell-specific DL/UL subband, according to an embodiment.

Referring to FIG. 2A, an active DL BWP 210 and an active UL BWP 215 do not overlap with a cell-specific UL subband 220, and therefore, a PDSCH will not be rate matched around the cell-specific UL subband 220. Accordingly, the limit of RateMatchPattern(s) per serving-cell may not be affected. For example, if there are four configured RateMatchPattern(s) per serving-cell, all of them may be applied.

Referring to FIG. 2B, an active DL BWP 230 and an active UL BWP 235 overlap with the cell-specific UL subband 220, and therefore, a PDSCH will be rate matched around the cell-specific UL subband 220. Accordingly, the limit of RateMatchPattern(s) per serving-cell may be affected as described above. That is, in this case, rate matching of a PDSCH crossing boundaries of DL subband in an SBFD operation is counted towards the limit of RateMatchPattern(s) per serving-cell.

According to an embodiment, when the limit of RateMatchPattern(s) per serving-cell or BWP is exceeded because rate matching of a PDSCH crossing boundaries of DL subbands is counted toward the limit of RateMatchPattern(s) per serving-cell or BWP, an error case may occur, one or more of the configured RateMatchPattern(s) per serving-cell or per BWP is not applied while the limit is exceeded, or a UE may not expect to perform rate matching of a PDSCH crossing boundaries of DL subbands, i.e., a gNB may operate so that rate matching of a PDSCH crossing boundaries of DL subbands does not occur. Here, the UE will not perform rate matching of a PDSCH crossing boundaries of DL subbands. For example, if the UE deviates from this behavior, it may be considered an anomaly or a violation of standard operating procedures, leading to network issues or performance degradation.

When considered as an error case, a gNB may need to avoid a situation in which the limit of RateMatchPattern(s) per serving-cell or BWP is exceeded.

When one or more of the configured RateMatchPattern(s) per serving-cell or per BWP are not applied until the limit is not exceeded, different rules may be used to determine which RateMatchPattern(s) per serving-cell or per BWP are not to be applied. For example, the RateMatchPattern(s) per serving-cell or per BWP with a lowest (or highest) ID may not be applied.

When a UE does not expect to perform rate matching of a PDSCH crossing boundaries of DL subbands, a gNB may ensure that a scheduled PDSCH is fully confined within a DL subband. That is, the gNB will configure a scheduled PDSCH to not overlap a UL subband.

According to an embodiment, a gNB may explicitly indicate, to a UE, when the rate matching of a PDSCH crossing boundaries of a DL subband is to be counted and which limit, i.e., the limit on RateMatchPattern(s) per serving-cell or per BWP, the counting is to be applied towards. For example, an indication or flag may be provided via higher layer signaling, i.e., at the medium access control (MAC) layer and above, such as through RRC, and may be part of PDSCH-Config. If such an indication or flag is not provided for a specific BWP, a UE may interpret the absence of the indication or flag as an indication that the BWP does not overlap with a cell-specific subband. However, if the BWP overlaps with a cell-specific subband, the UE does not expect to perform rate matching for a PDSCH crossing a DL subband and the gNB may configure the PDSCH to be fully confined within the boundary of DL subband, i.e., may not overlap the UL subband.

Similarly, when rate matching of a PDSCH crossing boundaries of DL subbands may be counted towards the limit on RateMatchPattern(s) per serving-cell, a gNB may indicate in which cell such operation is allowed. Specifically, an indication or a flag may be provided via higher layer signaling, such as RRC, and it may be part of ServingCellConfig. If not provided, the UE does not expect to perform rate matching for a PDSCH crossing a DL subband and the gNB may configure a PDSCH to be fully confined within the boundary of DL subband.

According to an embodiment, a UE may indicate, to a gNB, whether rate matching of a PDSCH crossing boundaries of DL subbands is counted towards the limit of RateMatchPattern(s) per BWP or towards or the limit of RateMatchPattern(s) per serving-cell.

According to an embodiment, the above-described limit on the number of possibly configured RateMatchPattern(s) per BWP or per serving-cell may remain unchanged due to rate matching of a PDSCH that crosses DL subbands' boundaries. More specifically, a UE may separately indicate a maximum number of supported cells or CCs, i.e., the number of cells or CCs that the UE can simultaneously connect to, in which a PDSCH crossing DL subbands can be rate matched. The UE may also separately indicate a maximum number of serving-cells or BWPs in which a PDSCH crossing DL subbands can be rate matched. According to this approach, the limits on the rate matching patterns are not affected.

Additionally, a UE can indicate, to a gNB, a type of PDSCH that can be rate matched for crossing a boundary of DL subband. The type of PDSCH may include a dynamic PDSCH or a semi-persistent scheduling (SPS), based on whether a PDSCH with repetition or without repetitions is supported. For example, a UE may indicate that it supports rate matching of a PDSCH crossing DL subbands for SPS only, for dynamic PDSCH without repetition only, etc.

A gNB may indicate, to a UE, in which BWP or cell, the UE is to rate match a PDSCH crossing a DL subband, as described above.

A UE may indicate, to a gNB, whether rate matching of a PDSCH crossing boundaries of DL subbands is to be counted towards the BWP or cell limits or counted separately.

According to an embodiment, an SBFD operation may turn on and off dynamically. Specifically, a symbol configured as an SBFD symbol, which includes DL subband(s) and UL subband(s), may be converted into a legacy symbol, either a DL/UL/flexible (F), via dynamic signaling such as a physical DL control channel (PDCCH) or a medium access control element (MAC-CE). In this case, a UE may dynamically perform rate matching of a PDSCH crossing DL subbands based on whether an SBFD operation is on or off.

In NR, a UE may be configured with multiple groups of rate matching pattern IDs for different DCI formats. Dedicated fields in scheduling DCI may indicate which group is applied. Additionally, each group may include up to maxNrofRateMatchPatternsPerGroup, e.g., 8, rate matching patterns. Additionally, there can be up to two groups of rate matching per certain DCI formats, e.g., rateMatchPatternGroup1, rateMatchPatternGroup2, rate MatchPatternGroup1DCI-1-2-r16, or rateMatchPatternGroup2DCI-1-2-r16.

When an SBFD operation can be dynamically turned on-off, rate matching of a PDSCH crossing DL subband boundaries may be counted towards the limit of rate matching patterns per group, e.g., it may be counted as β times, where β may be indicated via UE capability signaling or predefined, e.g., provided in specifications.

Since there can be more than one group of rate matching patterns per DCI format, e.g., rateMatchPatternGroup1, rateMatchPatternGroup2, rateMatchPatternGroupIDCI-1-2-r16, or rateMatchPatternGroup2DCI-1-2-r16, which of the rate matching groups is to be used for counting rate matching of a PDSCH crossing DL subband boundaries should be determined.

According to an embodiment, rate matching of a PDSCH crossing a DL subband in an SBFD operation that can be dynamically turned on-off can be counted as β times towards one group of the applicable DCI formats. For example, for DCI format 1_1, the counting can be towards the RateMatchPattern(s) of rateMatchPatternGroup1. Similarly, for DCI format 1_2, the counting can be towards RateMatchPattern(s) of rateMatchPatternGroupIDCI-1-2-r16.

Alternatively, a UE can indicate whether rate matching is to be counted towards the first or second group.

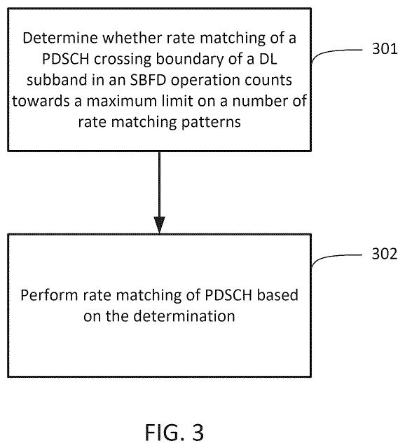

FIG. 3 is a flow chart illustrating a method performed by a UE, according to an embodiment.

Referring to FIG. 3, in step 301, the UE determines whether rate matching of a PDSCH that crosses a boundary of a DL subband in an SBFD operation is to be counted towards a maximum limit on a number of rate matching patterns. The maximum limit on a number of rate matching patterns, i.e., how many different rate matching patterns a UE can support, may depend on the UEs hardware and software capabilities, such as its processing power and memory. As described in the embodiments above, counting of rate matching of a PDSCH that crosses a boundary of a DL subband in an SBFD operation towards a maximum limit on a number of rate matching patterns may be avoided, e.g., when rate matching of a PDSCH around a UL subband may not be required.

In step 302, the UE performs the rate matching of the PDSCH that crosses the boundary of the DL subband in the SBFD operation, based on the determination.

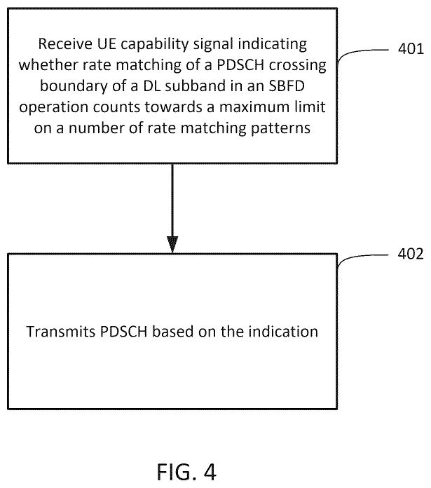

FIG. 4 is a flow chart illustrating a method performed by a gNB, according to an embodiment.

Referring to FIG. 4, in step 401, the gNB receives, from a UE, a capability signal indicating whether rate matching of a PDSCH that crosses a boundary of a DL subband in an SBFD operation is to be counted towards a maximum limit on a number of rate matching patterns.

In step 402, the gNB transmits, to the UE, the PDSCH based on the indication.

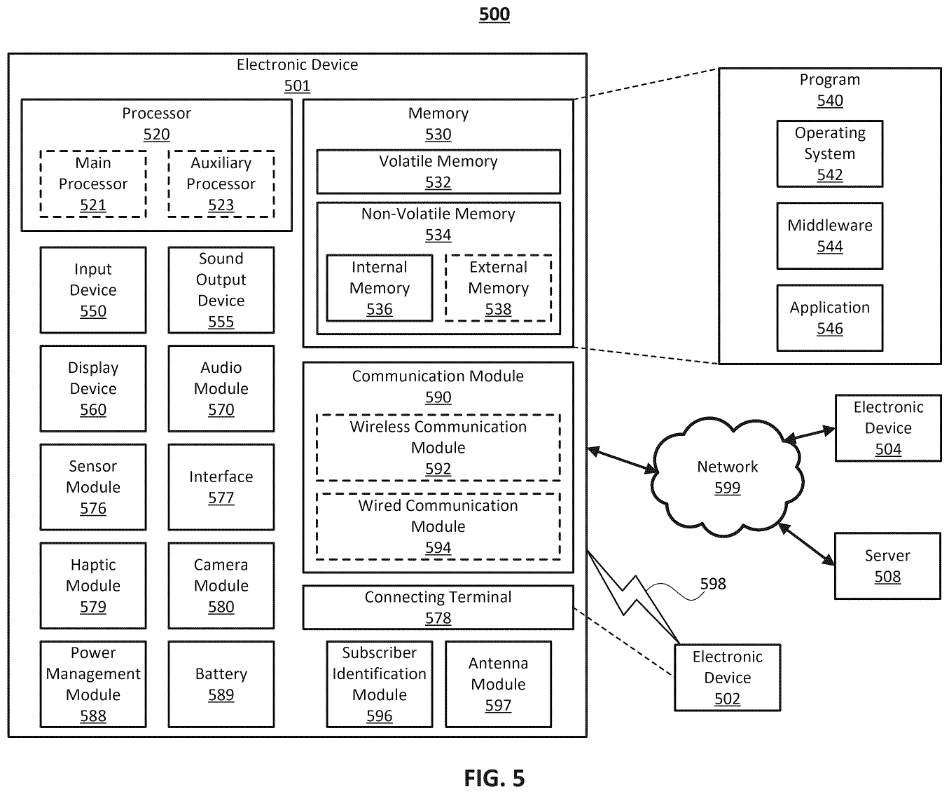

FIG. 5 is a block diagram of an electronic device in a network environment 500, according to an embodiment. For example, an electronic device 501 as illustrated in FIG. 5 may perform the method illustrated in FIG. 3.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations, e.g., the method illustrated in FIG. 3.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

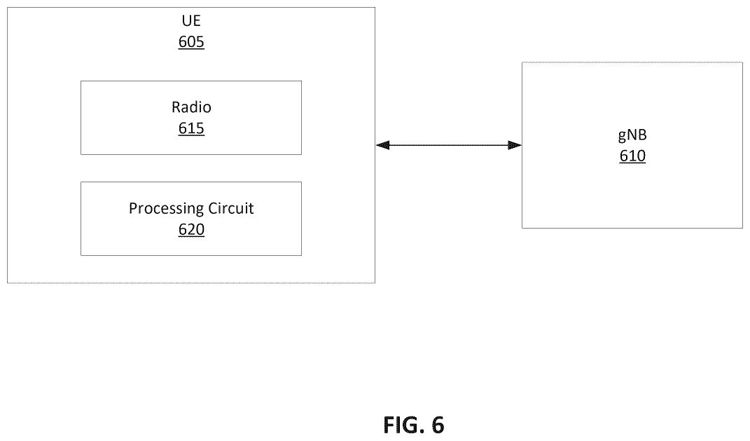

FIG. 6 shows a system including a UE 605 and a gNB 610, in communication with each other.

Referring to FIG. 6, the UE 605 may include a radio 615 and a processing circuit (or a means for processing) 620, e.g., processor 520 of FIG. 5, which may perform various methods disclosed herein, e.g., the method illustrated in FIG. 3. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), the method comprising:
determining whether rate matching of a physical downlink (DL) shared channel (PDSCH) that crosses a boundary of a DL subband in a subband full duplex (SBFD) operation is to be counted towards a maximum limit on a number of rate matching patterns; and
performing the rate matching of the PDSCH that crosses the boundary of the DL subband in the SBFD operation, based on the determination.

2. The method of claim 1, wherein the maximum limit on the number of rate matching patterns includes at least one of a maximum limit on a number of rate matching patterns per serving-cell or a maximum limit on a number of rate matching patterns per bandwidth part (BWP).

3. The method of claim 2, further comprising reducing the maximum limit on the number of rate matching patterns by a value of β, in response to determining that the rate matching of the PDSCH that crosses the boundary of the DL subband in the SBFD operation is to be counted towards the maximum limit on the number of rate matching patterns,
wherein the value of β is an integer value that is less than or equal to the maximum limit on the number of rate matching patterns.

4. The method of claim 3, further comprising transmitting, to a base station, a capability signal including an indication of the value of β.

5. The method of claim 4, wherein the capability signal indicates whether the value of β is to be applied to the maximum limit on the number of rate matching patterns per serving-cell, the maximum limit on the number of rate matching patterns per BWP, or both of the maximum limit on the number of rate matching patterns per serving-cell and the maximum limit on the number of rate matching patterns per BWP.

6. The method of claim 2, further comprising reducing the maximum limit on the number of rate matching patterns per BWP by a value of β and reducing the maximum limit on the number of rate matching patterns per serving-cell by a value of α, in response to determining that the rate matching of the PDSCH that crosses the boundary of the DL subband in the SBFD operation is to be counted towards the maximum limit on the number of rate matching patterns,
wherein the value of β is an integer value that is less than or equal to the maximum limit on the number of rate matching patterns per BWP, and
wherein the value of a is an integer value that is less than or equal to the maximum limit on the number of rate matching patterns per serving-cell.

7. The method of claim 6, further comprising transmitting, to a base station, a capability signal including an indication of the value of β and an indication of the value of α.

8. The method of claim 7, wherein the capability signal indicates whether the value of β is to be applied to the maximum limit on the number of rate matching patterns per BWP and the value of α is to be applied to the maximum limit on the number of rate matching patterns per serving-cell.

9. The method of claim 6, wherein the value of α is determined as a function of the value of β, or the value of β is determined as a function of the value of α.

10. The method of claim 2, wherein determining whether the rate matching of the PDSCH that crosses the boundary of the DL subband in the SBFD operation is to be counted towards the maximum limit on the number of rate matching patterns comprises:
determining the DL subband or an uplink (UL) subband as being cell specific or UE specific;
determining that the rate matching of the PDSCH that crosses the boundary of the DL subband in the SBFD operation is to be counted towards the maximum limit on the number of rate matching patterns per serving-cell, in response to determining the DL subband or the UL subband as being cell specific; and
determining that the rate matching of the PDSCH that crosses the boundary of the DL subband in the SBFD operation is to be counted towards the maximum limit on the number of rate matching patterns per BWP, in response to determining the DL subband or the UL subband as being UE specific.

11. The method of claim 1, wherein determining whether the rate matching of the PDSCH that crosses the boundary of the DL subband in the SBFD operation is to be counted towards the maximum limit on the number of rate matching patterns comprises:
determining if an active bandwidth part (BWP) overlaps with a cell specific subband; and
determining that the rate matching of the PDSCH that crosses the boundary of the DL subband in the SBFD operation is to be counted towards the maximum limit on the number of rate matching patterns per serving-cell or per BWP, in response to determining that the active BWP overlaps with the cell specific subband; and
determining that the rate matching of the PDSCH that crosses the boundary of the DL subband in the SBFD operation is not to be counted towards the maximum limit on the number of rate matching patterns per serving-cell or per BWP, in response to determining that the active BWP does not overlap with the cell specific subband.

12. The method of claim 1, further comprising:
determining that the maximum limit on the number of rate matching patterns is exceeded due to the rate matching of the PDSCH that crosses the boundary of the DL subband in the SBFD operation being counted towards the maximum limit on the number of rate matching patterns; and
in response to determining that the rate matching pattern limit is exceeded, performing one of:
identifying an error case;
not applying at least one of rate matching patterns configured to the UE, until the rate matching pattern limit is not exceeded; or
identifying that a base station is not configuring the PDSCH to cross the boundary of the DL subband in the SBFD operation.

13. The method of claim 1, wherein determining whether the rate matching of the PDSCH that crosses the boundary of the DL subband in the SBFD operation is to be counted towards the maximum limit on the number of rate matching patterns comprises:
receiving, from a base station, an indication of whether the rate matching of the PDSCH that crosses the boundary of the DL subband in the SBFD operation is to be counted towards the maximum limit on the number of rate matching patterns per serving-cell or per BWP; and
determining whether the rate matching of the PDSCH that crosses the boundary of the DL subband in the SBFD operation is to be counted towards the maximum limit on the number of rate matching patterns based on the indication from the base station.

14. The method of claim 1, further comprising transmitting, to a base station, a capability signal indicating an SBFD rate matching capability that is independent from the maximum limit on the number of rate matching patterns.

15. The method of claim 14, wherein the capability signal includes a maximum number of supported cells, component carriers, serving-cells, or bandwidth parts (BWPs) in which the PDSCH that crosses the boundary of the DL subband is rate matched.

16. The method of claim 1, further comprising receiving, from a base station, a configuration including one or more rate matching patterns that are subject to the maximum limit on the number of rate matching patterns.

17. A user equipment (UE), comprising:
a transceiver; and
a processor configured to:
determine whether rate matching of a physical downlink (DL) shared channel (PDSCH) that crosses a boundary of a DL subband in a subband full duplex (SBFD) operation is to be counted towards a maximum limit on a number of rate matching patterns, and
perform the rate matching of the PDSCH that crosses the boundary of the DL subband in the SBFD operation, based on the determination.

18. The UE of claim 17, wherein the maximum limit on the number of rate matching patterns includes at least one of a maximum limit on a number of rate matching patterns per serving-cell or a maximum limit on a number of rate matching patterns per bandwidth part (BWP).

19. The UE of claim 18, wherein the processor is further configured to reduce the maximum limit on the number of rate matching patterns by a value of β, in response to determining that the rate matching of the PDSCH that crosses the boundary of the DL subband in the SBFD operation is to be counted towards the maximum limit on the number of rate matching patterns,
wherein the value of β is an integer value that is less than or equal to the maximum limit on the number of rate matching patterns.

20. A method performed by a base station, the method comprising:
receiving, from a user equipment (UE), a capability signal indicating whether rate matching of a physical downlink (DL) shared channel (PDSCH) that crosses a boundary of a DL subband in a subband full duplex (SBFD) operation is to be counted towards a maximum limit on a number of rate matching patterns; and
transmitting the PDSCH based on the indication.
